(19) United States
(12) Patent Application Publication
(10) Pub. No.: US 2008/0141126 A1
(43) Pub. Date: Jun. 12, 2008

(54) METHOD AND SYSTEM TO AID IN VIEWING DIGITAL CONTENT

(76) Inventors: Vincent Lee Johnson, San Antonio, TX (US); Michael Downs Coon, Nacogdoches, TX (US)

Correspondence Address: WINSTEAD PC, P.O. BOX 50784, DALLAS, TX, 75201, US

(21) Appl. No.: 11/942,661

(22) Filed: Nov. 19, 2007

Related U.S. Application Data
(60) Provisional application No. 60/866,389, filed on Nov. 17, 2006.

(51) Int. Cl. G06F 3/00; G06F 3/048

(52) U.S. Cl. 715/273; 715/860

(57) ABSTRACT

A method designed to include a number of features which facilitate fast and accurate reading of text documents. The design of these features is based on research in the fields of visual perception, ergonomics, and usability. The method applies this research to create software which provides various assisted-reading modes.

### CROSS-REFERENCE TO RELATED APPLICATIONS

This Application claims priority to and incorporates by reference provisional application No. 60/866,389 filed on Nov. 17, 2006.

### BACKGROUND

1. Technical Field of the Invention

This invention relates in general to the field of viewing digital content, and more particularly to enhancing reading speed and comprehension.

2. Background of the Invention

Humans are gifted with varying abilities to read and comprehend written texts in both printed material and electronic documents. Studies have been done on the “readability” of text, i.e., ways of presenting text so that it may be more easily processed by the human brain for enhanced reading speed and comprehension. Those studies focus on issues of which font sizes, font types, number of words per line, etc. work best to enhance reading speed and comprehension.

Reading speed and accuracy in identifying target words is significantly impacted by factors including foreground color, background color, contrast between foreground and background, and text font. In some cases, the best performance is achieved using a combination of fonts and colors which differs from what a user indicates is his/her subjective preference. That is, the best performance is not necessarily achieved by allowing a user to select what he/she believes is the best or most attractive options.

Saccades lumps in the eyes' focal position) occur when the eyes move from word to word and at the end of each line of text when the eyes move down and left to the start of the next line. Saccades can negatively affect reading speed and accuracy in a number of ways. For example, long lines of text can cause inaccuracy in correctly identifying the start of the following line because the reader may skip lines during the return saccade and have to back up and identify the correct line.

### SUMMARY OF THE INVENTION

In accordance with the present invention, a method and system to aid in viewing digital content is provided which substantially eliminates or reduced disadvantages and problems associated with previous systems and methods.

In accordance with one aspect of the present invention, a method is provided for reading-assistance including receiving a string of text, the string of text comprising a plurality of words arranged in a predetermined order having at least a first word; receiving a list of words of interest; wherein the words of interest are a subset of the plurality of words; tagging each of the plurality of words that corresponds to a word of interest of the words of interest; displaying at least a portion of the plurality of words; highlighting each of a plurality of subsets of the plurality of words for a predetermined amount of time and in a predetermined order; wherein only one subset of the plurality of subsets is highlighted at a time; wherein an order in which the plurality of subsets is highlighted corresponds to the predetermined order of the plurality of words; and wherein a predetermined amount of time for highlighting a subset of the plurality of subsets that comprises a tagged word is greater than a predetermined amount of time for highlighting a subset of the plurality of subsets that comprises only non-tagged words.

More specifically, the present invention also includes wherein the list of words of interest including at least one word selected from the group consisting of user-defined keywords; search keywords used in a search to generate a document set; concept keywords relating to a subset of a plurality of documents; and linguistic keywords automatically generated based on linguistic processing. And wherein the highlighting step comprises increasing a font size. And also including highlighting a previously highlighted subset in response to user input. And also including displaying a word of a highlighted subset in an increased font and in a position above the displayed at least a portion of the plurality of words. And wherein the at least a portion of the plurality of words is displayed in a columnate format having columns of a predetermined width; and the width of the columns is related to a document type. And wherein tagged words are displayed in a bold font.

In accordance with another aspect of the present invention, a reading-assistance method including storing user-reading statistics; wherein the user-reading statistics comprise correlation data between a plurality of document types and a set of display settings used by a user to display each of the plurality of document types; storing user-specified preferences; wherein the user-specified preferences comprise settings for displaying at least one of the plurality of document types; receiving a document to be displayed, the document comprising a plurality of words arranged in a predetermined order; analyzing the document to determine a document type of the analyzed document; selecting a manner for displaying the document based in at least partial dependence on the user-reading statistics for the document type and the user-specified preferences for the document type of the analyzed document; and displaying the document in the manner. More specifically, the present invention also includes wherein the steps are performed in the order listed. And including updating the user-reading statistics after the manner for displaying has been selected. And wherein the manner for displaying is chosen from the group including a speed-reading manner; a utility-reading manner; a pleasure-reading manner; and a learning-reading manner. And wherein the document to be displayed is received from at least one of the group including a document search conducted using a web-searching algorithm; a file search conducted on an electronic storage device; and an email search conducted on an email viewing program. And wherein the set of display settings include one or more of: a scrolling speed; a highlight speed; a highlight size; an RSVP speed; a font size and a font color; a background color; and a column width. And wherein the user-reading statistics comprise correlation data between a document and a set of display settings used by a plurality of users to display the document.

In accordance with another aspect of the present invention, a method is provided for reading-assistance including receiving a string of text, the string of text and comprising a plurality of words arranged in a predetermined order; storing a list of words of interest; wherein the words of interest are a subset of the plurality of words; analyzing the string of text for the words of interest; wherein at least one area of the string of text comprising a relatively high concentration of words of interest is identified as important; wherein at least one area of the string of text comprising a relatively low concentration of words of interest is identified as non-important; displaying the string of text; wherein each of a plurality of subsets of the string of text are displayed for a predetermined amount of time and in a predetermined order; and wherein a predetermined amount of time for displaying a subset of the string of text corresponding to the at least one area identified as important is greater than a predetermined amount of time for displaying a subset of the string of text corresponding to the at least one area identified as non-important. Also including wherein the list of words of interest comprises keywords used in a database search. And wherein the list of words of interest comprises words from at least one area a user has tagged as important. And wherein the string of text is an email. And including using the list of words of interest to locate areas of importance in a plurality of documents.

The above summary of the invention is not intended to represent each embodiment or every aspect of the present invention. Particular embodiments may include one, some, or none of the listed advantages.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 shows an example of a highlight mode;

FIG. 2 shows an example of a columnate mode;

FIG. 3 shows an example of a “circle of light” mode;

FIG. 4 shows an example of a keyword-highlighting mode;

FIG. 5 shows an example of a Rapid Serial Visual Presentation (RSVP) mode;

FIG. 6 is a flowchart of an example of one embodiment of the present application;

FIG. 7 shows a user-mode display module;

FIG. 8 shows a speed-reading module;

FIG. 9 shows a document-set view;

FIG. 10 is a flowchart of an example of a search;

FIG. 11 shows an application-integration module;

FIG. 12 shows some additional processes; and

FIG. 13 shows an electronic device with a communication interface.

### DETAILED DESCRIPTION OF ILLUSTRATIVE EMBODIMENTS OF THE INVENTION

Attentional blink is a phenomenon observed when a reader is presented with a succession of visual stimuli. When a reader is presented with a sequence of visual stimuli in rapid succession, the reader will often fail to detect salient targets that follow in close temporal proximity to previous salient targets. This phenomenon can arise in a variety of situations including text scrolling across or down/up a display, or when a series of letters, numbers, words or symbols are flashed on a screen. For example, in Rapid Serial Visual Presentation (RSVP) a reader is presented with sequences of words presented in the same spatial location on a screen. If a participant detects a salient target stimulus in the stream, he or she will often fail to detect a second salient target occurring after the first one. Although the precise cause of attentional blink is unknown, one theory suggests that it is caused by a delay-of-processing. According to that theory, the attentional blink deficit is said to arise from the inability to process a second stimulus when the person's cognitive processes are busy processing a first stimulus. It is suggested that anything that increases the difficulty of processing the first stimulus will result in a greater attentional blink deficit. In this two-stage system, all stimuli are processed to some extent by an initial parallel stage, and only salient ones are selected for in-depth processing in order to make optimum use of limited resources at a later serial stage. One curious aspect of attentional blink is that it usually includes “lag 1 sparing,” meaning that targets presented very close together in time (at “lag 1” or consecutively in the RSVP stream) may not be affected by the attentional blink, even though items presented at slightly greater lags are significantly impaired.

One embodiment of the present invention relates to a reading interface which allows a user to select from a limited number of options to optimize the readability of the text. The foreground/background color combinations and the text font and size have been selected based on objective usability research rather than simply by user preference. Another embodiment relates to a software-based application that uses advanced search techniques to import data in the form of data files and other resources and display those files to a user based upon a set of preferences and speed-reading techniques. Other embodiments are designed to provide various assisted-reading modes which may include a number of features to facilitate fast and accurate reading of text documents based on research in the fields of visual perception, ergonomics, and usability. Various embodiments of the present application are adapted to be implemented on an electronic device such as, for example, a personal computer. Various other embodiments are adapted to be implemented on other electronic devices such as cell phones, PDAs, or any other device for displaying digital data. For example, RSVP is currently being investigated as a possibility for displaying documents on devices with small displays such as mobile phones or PDAs.

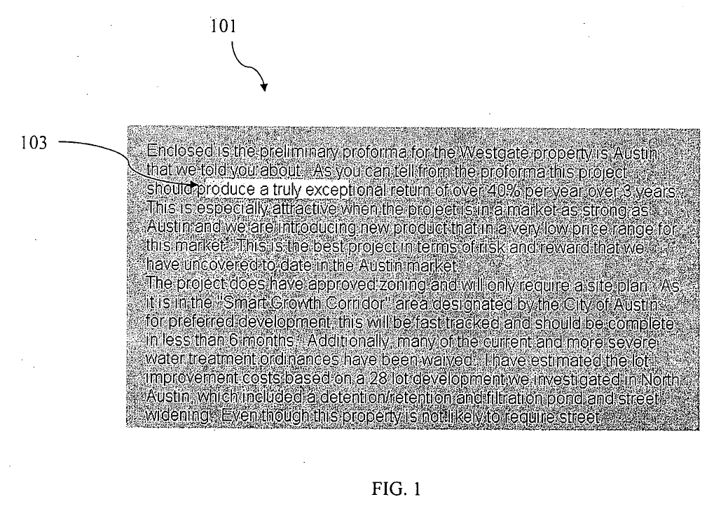

FIG. 1 shows an example of text displayed in a highlight mode where a highlighted portion 103 of a text block 101 can be seen. The highlighted portion 103 typically moves along the text from left to right so that the reader is to read the text that is being highlighted. In one embodiment, the entire text may be shaded and the highlighted portion may be lightened. In other embodiments, the entire text is lightened and the highlighted portion is darkened. The text that is being read can be copied from a document or a website and pasted into an interface window, or the program can be used to read entire documents. The highlight mode assists the reader by guiding the reader's eyes to the desired subsequent portion of text. In some embodiments, readers may purposefully set the highlight mode to skip lines in order to increase speed while skimming the text. Text highlighting may also be used to guide the reader's eyes in moving through the text at a consistent speed. The highlighting speed can be set by the reader to a comfortable level, and the highlighting can be configured to highlight each line of text or skip lines just as many speed readers don't focus on every successive line. This mode uses the natural ability of the eye to track motion in order to guide the reader's pace.

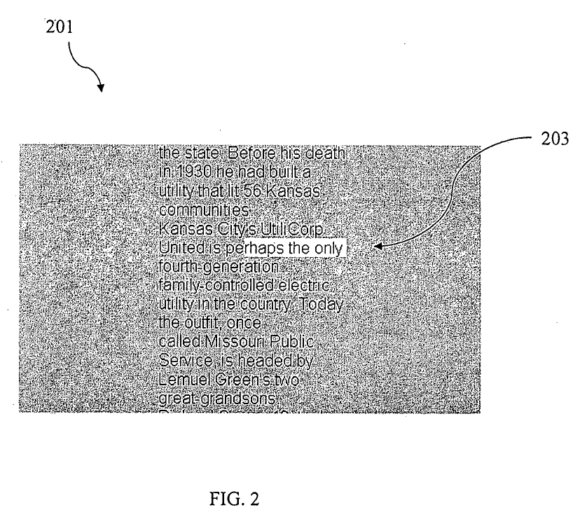

FIG. 2 shows an example of text displayed in a columnate mode in which the margins of displayed text 201 have been modified to present a narrow column. In the example shown, the columnate mode is shown in conjunction with the highlight mode so that a highlighted portion 203 of the displayed text 201 can be seen. The columnate mode narrows the column width of the text 201 to a length which reduces the risk of error and restricts each line of the text 201 to a visual angle which minimizes reader fatigue. The column width in the columnate mode may be set to a default based on optimum visual angle to reduce saccades or it may be configured by the user to adapt to different font and display situations. This minimizes the inaccuracy caused by a saccade from the end of one line to the start of another. In addition, it reduces reader fatigue by limiting the text to a visual angle which the eye can track without the reader physically moving his/her head.

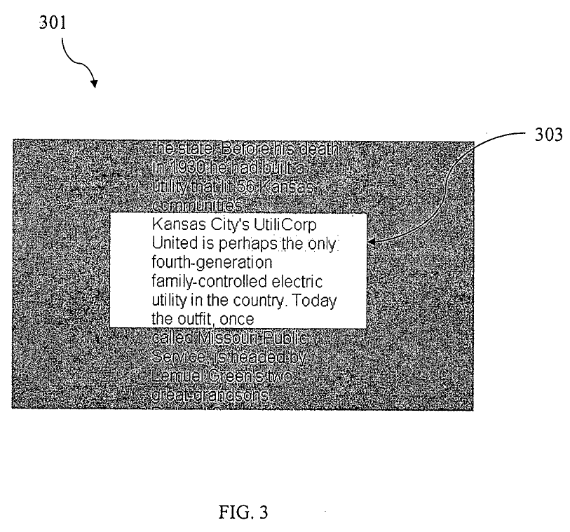

FIG. 3 shows an example of a “circle of light” mode. The “circle of light” mode provides a highlighted area 303 that is fixed and the document 301 scrolls past from bottom to top. For example, a central portion of the highlighted area window may contain highlighted text and the text of the document 301 may scroll past this fixed highlighted area. While referred to as a “circle,” the highlight pattern can take the form of a rectangular box highlighting the central part of the text, a highlighted bar spanning the width of the display, a circle/elliptical highlight over the central part of the text, or other desired shape. In various embodiments, a user has the option of selecting between a main highlighting mode in which the highlight moves through fixed text or the “circle of light” mode in which the highlight (which can be a horizontal bar of a configurable height, a circular “lens,” or other shape) is fixed and the document scrolls past. In other embodiments the font of the text under the circle of light is increased relative to the font of the text before and after the circle.

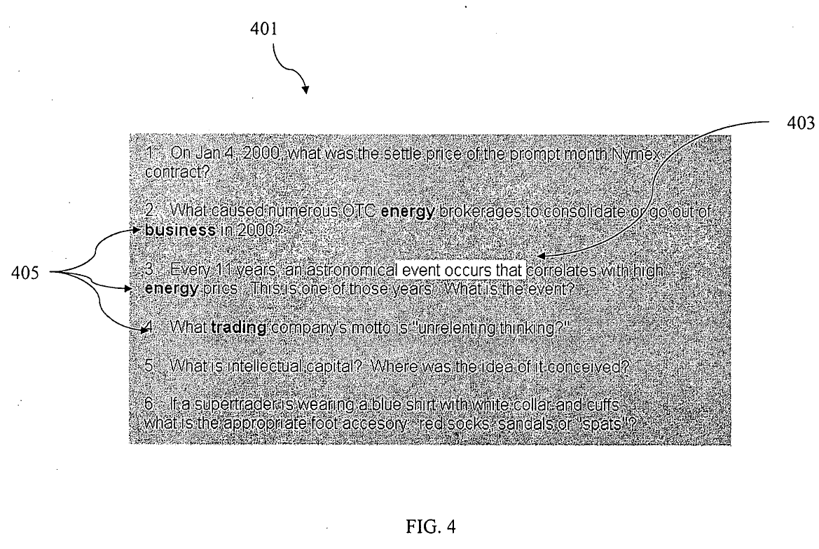

FIG. 4 shows an example of text 401 displayed in keyword-highlight mode in which user or system-selected keywords 405 are highlighted in a way to set them apart from both the main text and highlighted text 403 when used with the highlight reader-assist mode. For example, the user or system-selected keywords 405 may be search terms used to create a list of documents. When a document set being viewed is the result of a keyword-based search, the keywords used in the search may be highlighted in the document content to indicate relevant portions to the reader. This highlighting can take several forms (e.g. bold text, underlined text, color difference from main font color) which sets the keyword text apart from both the main text and the highlighted text. In another embodiment of the keyword-highlighting mode, only the text of a sentence containing a keyword is highlighted by the moving-text highlight. This mode can also be expanded, for example, to show the sentence before, the sentence containing, and/or the sentence after each keyword.

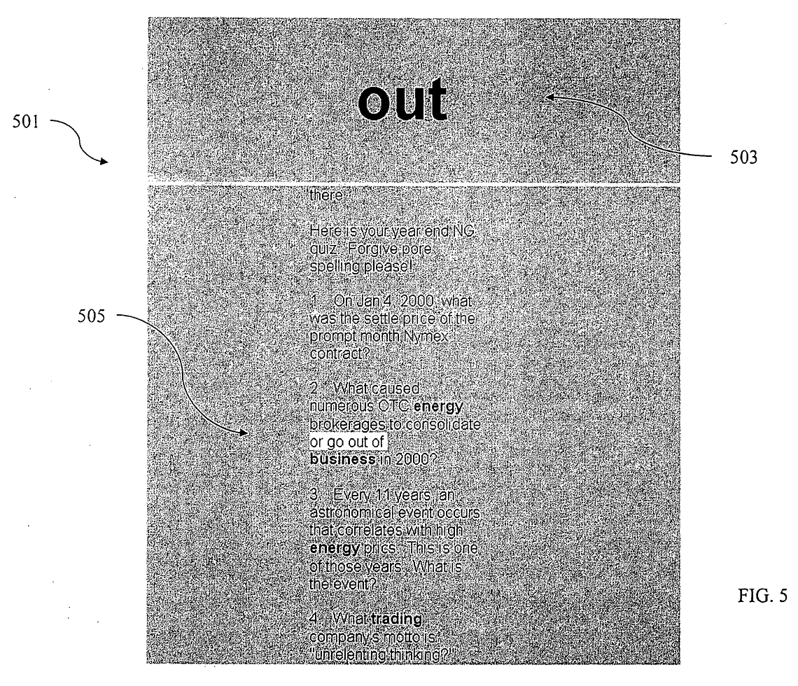

FIG. 5 shows an example of Rapid Serial Visual Presentation (RSVP) 501 in which text is displayed one word at a time 503 in a flash-card-style interface. In addition to the RSVP single-word display 503, various embodiments provide an interface that simultaneously displays the full text in a highlight-mode window where, for example, a portion 505 can be highlighted to provide document organization context not provided by isolated single-word displays. Providing a textual context may be advantageous when, for example, the RSVP text refers to a figure and the user wants to quickly view the area of the document text where the figure is located. Other embodiments contemplate highlighting text only after a user pauses the RSVP so that the highlighted text does not distract the user while the RSVP program is running.

One drawback of RSVP and other reading-assist modes is that a reader may miss a word or words following a word of interest. This phenomenon, known as attentional blink, refers to a gap in the reader's attention after a target word or concept is identified in the text. When a reader finds some information of value, he/she may seem to continue reading but not fully process text following the information of value because his/her mental attention remains on the information of value (i.e., an item of interest).

A linguistic process may be run on the document to be viewed to automatically tag linguistic keywords such as, for example, proper nouns that may be items of interest to a reader. Therefore, the reading-assistance modes can be configured, for example, to display proper names for a longer period of time than prepositions. Also, pauses can be inserted after various punctuation marks such as commas and periods. Other keywords that may be tagged include user-defined keywords, search keywords, and concept keywords. A concept keyword may be a word or words that only relate to a subset of a larger set of documents. When a user identifies items of interest, the user may insert a tag identifying each item. In the above-mentioned reading-assist modes, to overcome the problems associated with attentional blink, a user may set a program to automatically reverse and replay text being displayed. The amount of text replayed is typically based on the current reader's speed setting and the average time duration of attentional blink as identified by visual processing research. For example, in FIG. 4, when the highlight 403 crosses a search term 405, the highlight 403 may remain on the search term for a longer period of time, may back up a user-specified number of words, or may back up for a user-specified length of time. Additionally, keyword search terms in a document may also be autotagged as content of interest. For example, when a user searches a database, the internet, a document, or a plurality of documents using certain keywords, the keywords may be tagged as content of interest. When a reading-assistance mode displaying text encounters a tagged keyword, the reading-assistance mode may pause at the keyword or may back up. Additionally, when a user takes an action, such as clicking on a mouse or other computer input, some embodiments can be adapted to automatically back up and replay a portion of the text that the user may have missed while carrying out the action.

The reading-assist modes described above also may be adapted to improve a user's speed-reading techniques. For example, automatic scrolling in a highlight mode eliminates the need for reader interaction to scroll through long documents. Additionally, a marquee mode, in which the text scrolls from right to left in a single line, tends to eliminate saccades and reduce reader fatigue. In addition to the scrolling marquee, the interface of various embodiments simultaneously displays the full text in a highlight-mode window which provides document organization and context not provided by the single scrolling line. Another example of an embodiment implementing the above-mentioned modes includes a skim mode to provide a highlighted display that highlights only the first sentence of each paragraph. Additionally, article deletion provides a mode in which grammatical articles (“a,” “and,” “the,” etc.) are deleted from the text to provide more succinct content which retains information content in an essentially unaltered form.

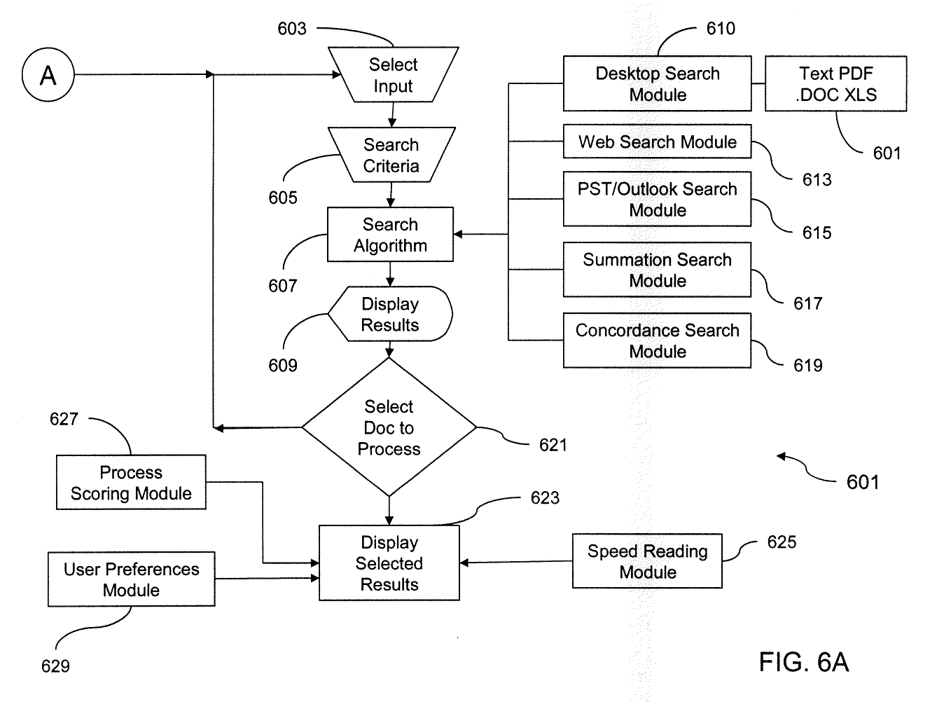

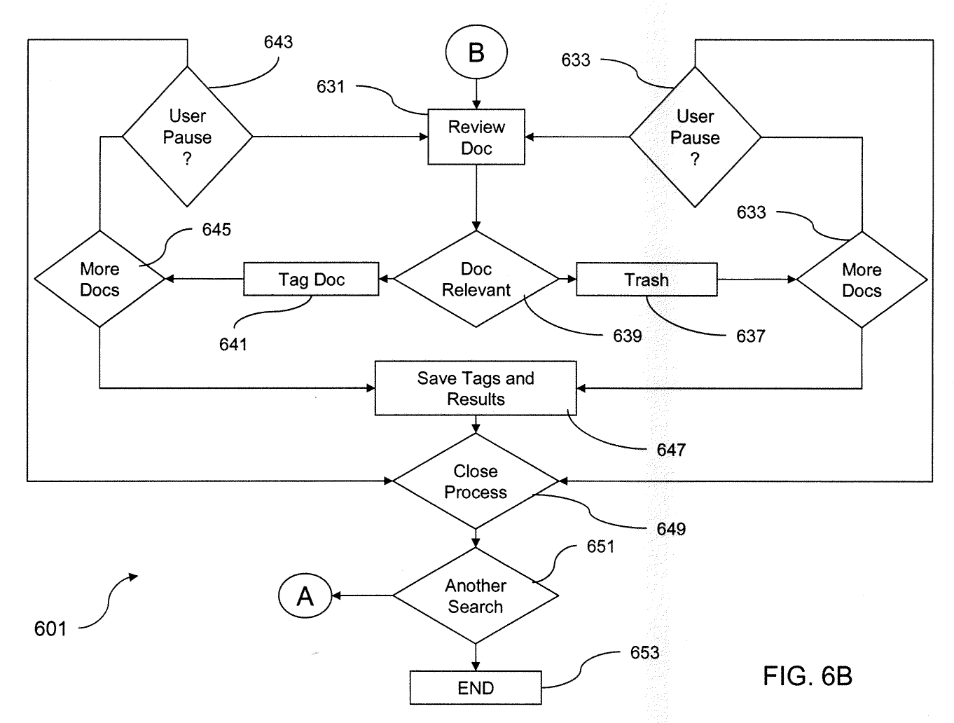

FIG. 6 shows an example of reading-assistance process. The process 601 begins when a user selects a search input 603 and search criteria 605. The search algorithm 607 uses a desktop search module 610; a web search module 613; a PST/OUTLOOK search module 615; a SUMMATION search module 617; and a CONCORDANCE search module 619. The desktop search module 610 can be used to view in the manners described herein the results of a search the contents of an electronic device, such as a computer. The web search module 613 can be used to view in the manners described herein the results of a web search such as a GOOGLE or YAHOO search. The PST/OUTLOOK search module 619 can be used to view in the manners described herein the results of a search of emails located either on an electronic device or on the web. The SUMMATION search module 617 and the CONCORDANCE search module 619 can be used to view in the manners described herein the results of a document search. In various embodiments, the search algorithm 607 is adapted to incorporate various other searches for collecting electronic data to be viewed. Search results are displayed at step 609 and the user selects documents to process at step 621. If no documents are selected at step 621, the user is prompted to select different search criteria at step 603. After the user has selected search results, the selected search results are displayed in the CDR at step 623. The manner in which the search results are displayed at step 623 depends on input from a speed-reading module 625, a process-scoring module 627, and a user-preferences module 629. The user reviews a selected document at step 631 and decides whether the selected document is relevant or not at step 639. If the document is not relevant, it will be trashed at step 637 and the user can review other documents at step 635. If the document is relevant, the user can tag the document at step 641 and review more documents at step 645. The documents that were tagged and the search results set can be saved at step 647. After a session has been saved, the process 601 is closed at step 649 and the user is asked whether to close the session or conduct another search at step 651. The session ends at step 653 if the user chooses not to perform another search.

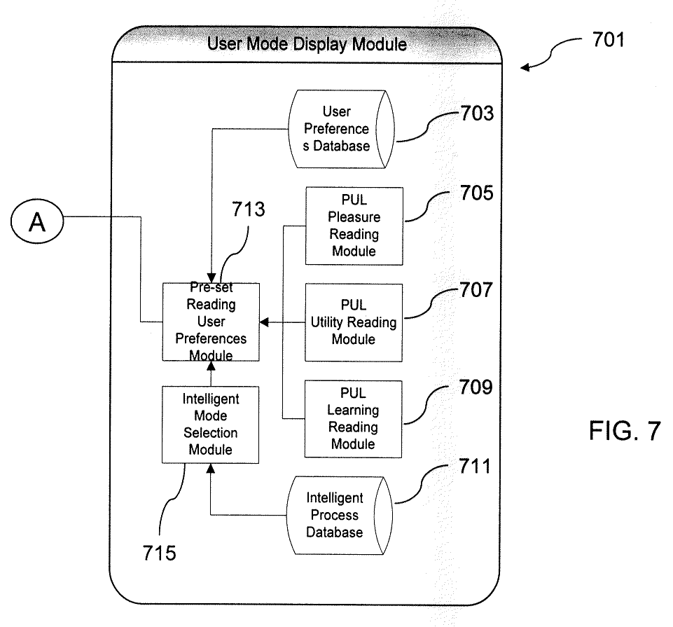

FIG. 7 is a diagram of a user mode display module to provide a number of configurable options which may assist the reader in processing text material. User mode display module 701 also records statistics on documents read by the user including length of document, format of document, and user-selected reading mode (or preset) configuration. These statistics are stored in a user-preferences database 703. The user preferences database 703 that may include statistical data on how the reader has read documents in the past. The user mode display module 701 may also include a number of user-defined modes that allow the user to specify how certain types of documents should be read. In the embodiment shown, the presets include a pleasure reading module 705, a utility reading module 707, and a learning reading module 709. Additional user-named presets can also be configured. These presets allow the user to save a set of configurations including but not limited to font size, font/background color, highlight mode, columnate mode, reading speed, and document opening modes. Individual users may prefer certain settings for different kinds of reading; therefore, preset buttons allow the user to easily select a set of configurations.

An intelligent process database 711 may include information showing how certain types of documents have been or should be read. The information may include both general statistical information and linguistic information. The linguistic information may include, but is not limited to, information on how a document of a certain length containing a certain density of keywords should be read. The intelligent process database 711 may also include statistics on specific documents read by other users, for example, in a large business entity, statistical data can be compiled from the way other readers of the entity have read the same document. An intelligent mode selection module 715 uses at least one of document meta-data, Bayesian statistical analysis, and linguistic processing to analyze a document and select a reading mode. The reading mode may be selected based on how the user has read similar documents statistics to predict a reading mode most appropriate for each new document based on the user's reading habits for similar documents and analysis of the type of document based on length, format, and other characteristics. When the intelligent mode selection module 715 is enabled, each new document may be profiled using Bayesian statistical analysis or other statistical analyses. The pre-set reading user preferences module 713 and the intelligent mode selection module 715 work together to apply all the data to predict how a certain document should be read. In various embodiments, a user may have a default preference (e.g. currently reading in pleasure mode) but the mode selection may override that setting based on document characteristics. After the reading method has been selected, the user mode display module sends this information to the document display engine 1213 which is marked as A in FIG. 7.

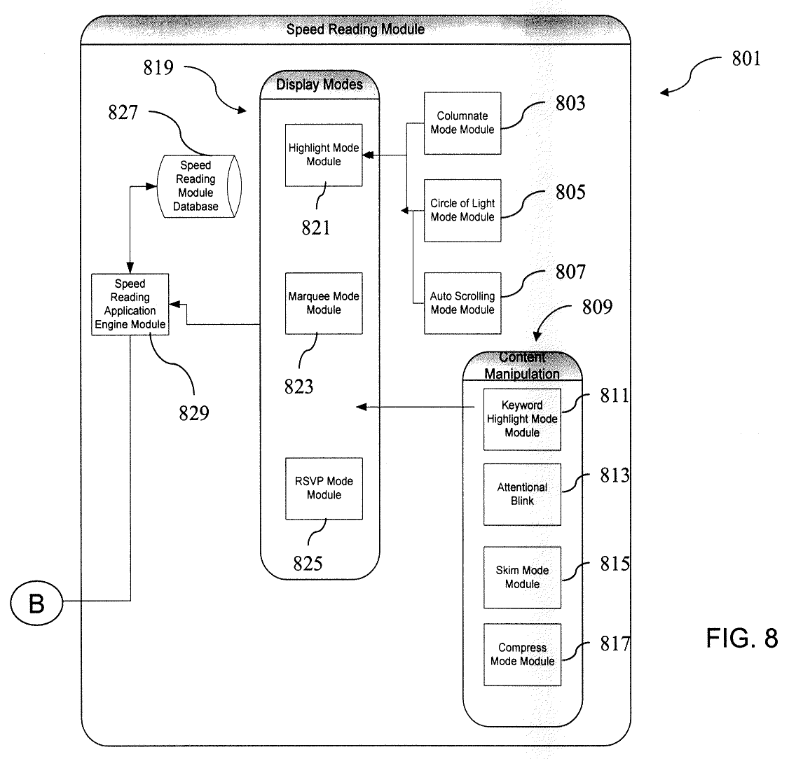

FIG. 8 shows a speed reading module 801 which enables a user to simultaneously display the same document in different reading modes. A content manipulation block 809 includes a keyword highlight mode 811, an attentional blink module 813, a skim mode module 815, and a compress mode module 817. Each of the above-mentioned functions can be incorporated into the other display modes 819, which include a highlight mode module 821, a marquee mode module 823, and an RSVP mode module 825. The highlight mode module 821 includes a columnate mode module 803, a circle-of-light mode module 805, and an auto-scrolling mode module 807. A speed-reading application engine module 829 can combine the display modes 819 with information from a speed reading module database 827 for a further customized reading experience. Outputs B from speed reading application engine module are sent to a document display engine (not explicitly shown).

In various embodiments, the display time for displaying words in the highlight mode or in the RSVP mode can be adjusted based on whether a word is or is not in a subset of a group of “tagged” words. The group of tagged words may be formed from, but not limited to, a user-defined set of keywords, keywords used to generate a document set, concept keywords that may be important for a certain set of documents, and/or automatically flagged words based on linguistic processing. An example of automatically flagged words may include, but is not limited to, proper names, foreign phrases, or other sets of words. The display time may be lengthened for the above mentioned words because the words may be important and therefore may cause attentional blink as the reader mentally focuses on the word of interest.

By combining various display modes, a user can customize settings to achieve optimal results. For example, the user can display both a highlighted mode and RSVP such that the word displayed in RSVP corresponds to the center of the highlighted portion. This simultaneous display provides complementary reading modes to enhance the effectiveness beyond what is capable in a single mode. There are multiple benefits of simultaneous display. For example, when multiple modes such as highlight mode and RSVP are used together, the user enjoys the benefits of both modes while offsetting their drawbacks. In another example, a minor drawback of the RSVP mode, a lack of context for the overall document, can be overcome by using the RSVP mode along with the highlight mode. When RSVP and highlight modes are used together, the user can view the document structure peripherally while still focusing on the RSVP presentation for optimal speed reading. Additionally, when multiple modes such as highlight mode and RSVP are used together, the user can shift his/her attention between the modes as a means of reducing fatigue and inattention. The simultaneous side-by-side display of different reading modes provides features which are unavailable when a single mode alone is displayed and provides a solution that is greater than the sum of the parts.

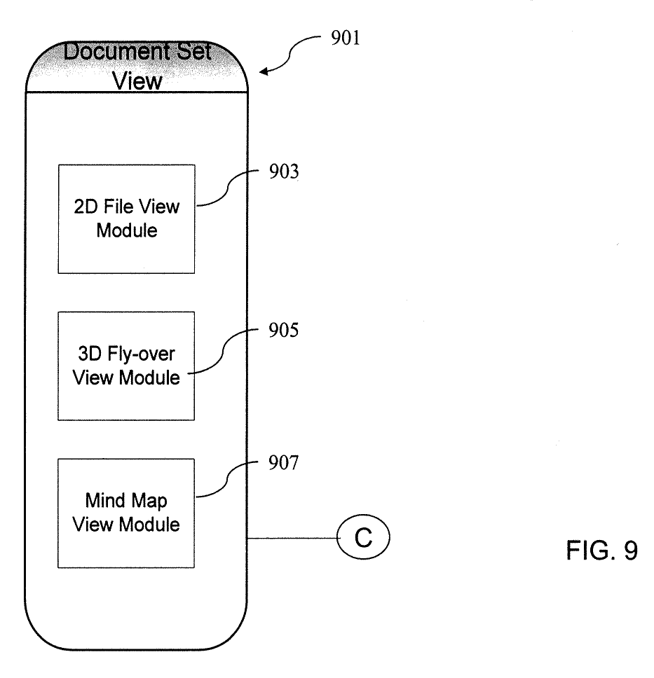

FIG. 9 shows a document set view 901 using which a set of documents can be reviewed in a number of interfaces. For example, when a user saves a number of documents, such as text documents or photos, into a folder, the name of folder may not convey fully the contents of the folder. If the user wishes to explore the contents of the folder, the user may wish to peruse the titles of the documents contained in the folder or may wish to skim the text of the documents in the folder. For example, the document set view 901 includes three modes for viewing document sets: A 2D File View Module 903; 3D Fly-over View Module 905; and Mind-map View Module 907. The 2D File View mode may, for example, represent the documents in a simple table displaying document names and metadata or in an expandable hierarchy similar to a file system display of folders, subfolders, and files. In either case, individual files can be grouped or sorted based on their metadata (name, date, creator, etc.). This view is referred to as “2D” to distinguish it from the more dynamic and graphical 3D models. The 3D Fly-over View represents documents sorted and grouped by metadata in a way very similar to the 2D view, but each file is represented as an icon, and the groups and sorting are represented by stacks and clouds of icons in a three-dimensional representation. The three-dimensional view provides a more flexible and intuitive interface than the simple two-dimensional list. In addition, the icons representing each file can visually represent certain metadata to provide more immediately-accessible information to the user. The Mind-map View represents a document set in a “mind map” or network-style diagram. Relationships between documents are represented both by their spatial location and by relationship path indicators. The network relationships may be created based on different metadata in order to show different relationships to the user. For example, a set of emails might show relationships between senders and receivers in one way and also show grouping by subject, company, or other information.

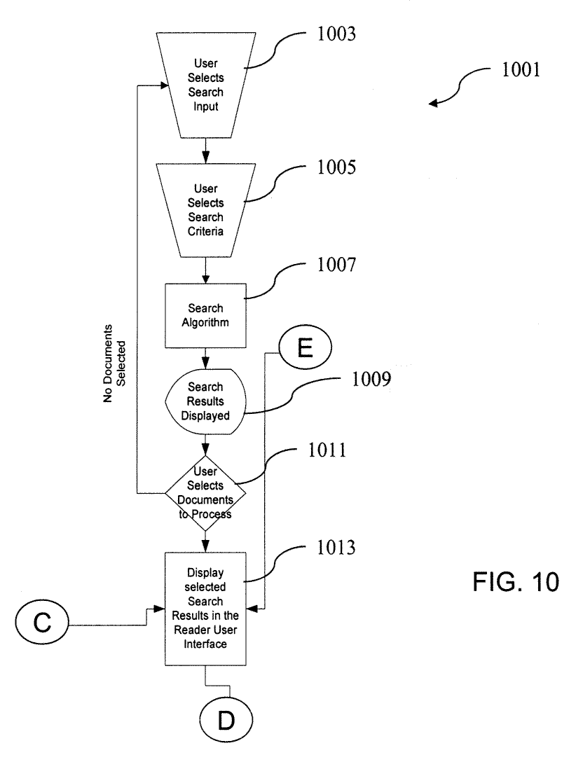

FIG. 10 is a flowchart 1001 of a user searching for documents to be displayed. A set of documents might, for example, include search results from a CONCORDANCE database, a set of emails, files located on a computer file system, web URLs resulting from a web-based search, or many other types of collections. Other embodiments may include the capability to sort, view, and tag files on the local file system or the Internet using search source inputs. While still other embodiments may have the capability to sort, view, and tag files on the local file system using other search source inputs (e.g. online search, email repository, etc.). The searching algorithm may also include, but is not necessarily limited to, one or more of the following: searching a local file system; searching the internet; searching online or remote file systems; previewing search results; allowing the user to process search results by displaying, tagging, noting, and/or discarding documents; saving processed documents and corresponding tags, notes, and other metadata. The search interface allows the user to specify the input files/location for the search as well as what parameters are to be used for the search. A search algorithm 1007 may include, but is not limited to, the following parameters: filename and file mask; date/time; file contents; extended file system search using such tools as third part search capabilities; local resources such as email systems or document repositories; online searches via online search engines; and specific online resources (e.g. RSS feeds or archive sites). A pre-process screen, such as in step 1011, allows the user to re-sort/prioritize search results before browsing file content.

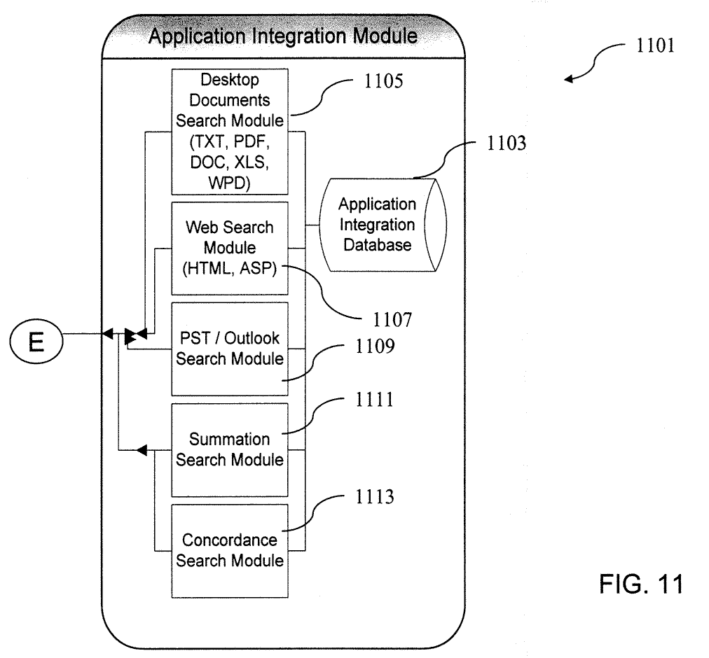

FIG. 11 is an application integration module 1101. The application integration module 1101 includes an application integration database 1103 to help facilitate the integration of a reader-assistance mode with a third-party application, such as an email program. In the embodiment shown, the application integration module 1101 includes a desktop document search module 1105, a web search module 1107, a PST/OUTLOOK search module 1109, a SUMMATION search module 1111, and a CONCORDANCE search module 1113. The results of various searches are sent to a display 1013 to display the selected search results in the reader user interface, labeled “E” in FIG. 11. Various other embodiments may integrate other types of searches, utilize other types of search engines, and search other types of databases. Various embodiments may be designed to integrate with existing workflow in order to facilitate reading without taking the user outside their normal process. For example, integration with the CONCORDANCE search module 1113 allows a search run within a CONCORDANCE database to be sent to “E” so the results can be speed-read. As another example, integration with the PST/OUTLOOK search module 1109 allows a user to apply multiple speed reading methods within their existing email reading pane.

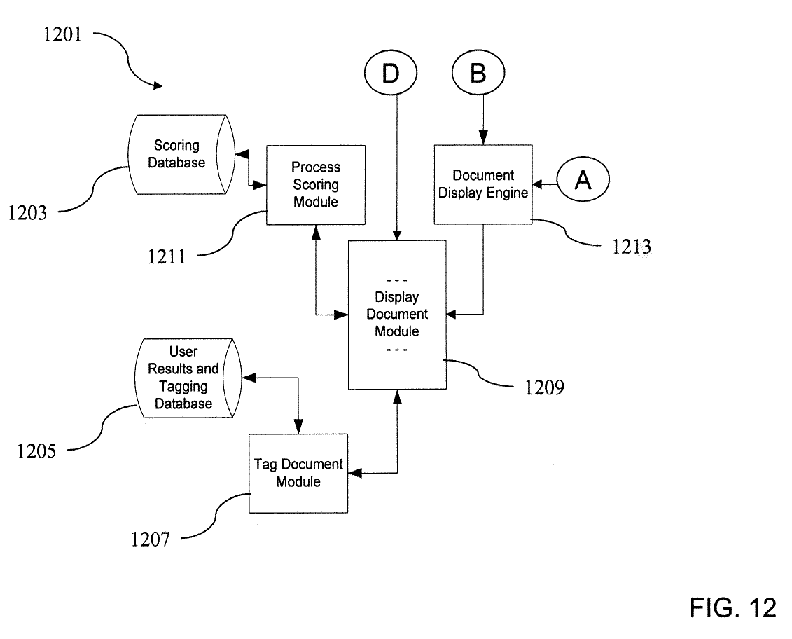

FIG. 12 is a diagram 1201 of various additional processes. A tag document module 1207 allows a user to identify concepts or keywords in documents. In addition to saving tags to a user results and tagging database 1205, the tags can also be fed back to integrated applications such as CONCORDANCE. Various embodiments may include multiple database storage options for document storage, which may, for example, be in XML format in some embodiments. Other embodiments may include a module that allows the user to add tags, notes, or bookmarks to documents for future reference.

In addition to tagging, various embodiments provide an option to annotate a document and file the document. Various embodiments allow action-based tags (such as an email delete or file action) to be used by a user so that an action taken within the display document module 1209 to be reflected in the integrated application. A process scoring module 1211 includes a feature enabling compiling of reading statistics including when a document was opened, how long it was open, the reading speed at which it was processed, and the mode in which it was processed. These statistics are saved in a scoring database 1203. In various embodiments, the actions performed on a file include actions capable of being performed on, for example, an email such as, for example, delete, move, or other action taken on an email. When a user reviews a file, for example a document, an email, or other electronic data, the user can tag them based on concepts and keywords in order to apply meta-data and the user can also tag them with actions such as “delete,” “move to folder X,” or other similar action. The action taken by the user may then be relayed to a controlling application. For example, if a user uses OUTLOOK to organize emails, and the user tags an email, an embodiment may relay a message to OUTLOOK corresponding to the action taken by the user. Similarly, if a user is viewing a file stored on an electronic device and takes an action, such as deleting the document, an embodiment may send a signal to the file system corresponding to the action taken by the user so the action could be performed on the source document.

Various embodiments are adapted to assess a user's current reading level and track increases in reading speed and comprehension. The reader statistics can be used to track if and when specific documents were accessed so that, for example, a parent can track the reading progress of a child. The statistics may also be used to provide data on the amount of reading done by individual users so that a reader's performance can be evaluated. The statistics and records of reading modes for different documents provide profiling of document types and reader choices which can be used to provide intelligent mode selection when new documents are opened. The interface and functionality of some embodiments may include scoring features that allow the user to measure progress and productivity. They may also include an enterprise scoring system that allows an administrator or manager-level supervisor to score the productivity of groups of workers.

A display document module 1209 may be used to display documents being processed. Documents may be processed sequentially based upon the order in the document queue. The document display is governed by the preferences set by the user. The document display is displayed using one or more speed-reading techniques to help increase document processing. The user has the ability to quickly and easily review, tag, and file documents. The interface is designed using advanced human factors and in such a manner that the components of the design are intuitive and easy for the user. The process scoring module 1211 may track the processing speed of a user and render scores for each processing session and overall scores for the job.

Various other embodiments provide for a stand-alone application or a plug-in application that can be used with third-party desktop or Internet-based applications. Other embodiments may include algorithms for displaying data and documents in a manner which encourages and facilitates rapid human processing or speed reading techniques of those documents. The desktop display of one embodiment may include one, some, or none of the following features: a search results folder; a main document display; tagged document folder; and trash document folder. The interface of various embodiments may include the following features: search; document queue; tagged documents folders; “game” stats; preferences; trash folders; main document; full screen; split screen; quick processing screen; new tab search set; save processing; and change order of documents.

As part of the document processing, in some embodiments, the user may be able to perform one, some, or none of the following functions while reviewing documents: revise document priority for display; view documents; tag keywords; annotate documents; bookmark documents; drag documents to storage folders; drag documents to trash; return documents to search results folder; save entire desktop workspace; save search results for future processing; empty trash; and search tagged, bookmarked, or annotated documents. Some embodiments allow the user to save processing sessions at various points. Some of the document control tools that may be included in various embodiments include, but are not limited to: go to page; go to first document; previous document; previous page; process; stop process; next page; next document; last document; and trash. Some of the user-display options may include one, some, or none of the following: tagging options; display options; colors (foreground and background); font (size and type); highlight keyword/phrase; cadence; image on/off; format options; grammar compression; relevance extraction; and speed reading options.

Other embodiments are adapted to aid a user in reading text directly from a website. In one embodiment, a user copies text from a website and pastes the text into an application window. The text is then manipulated according to which reading-assistance mode selected and the selected parameters. In an alternative embodiment, a user merely highlights text and the application automatically manipulates the highlighted text.

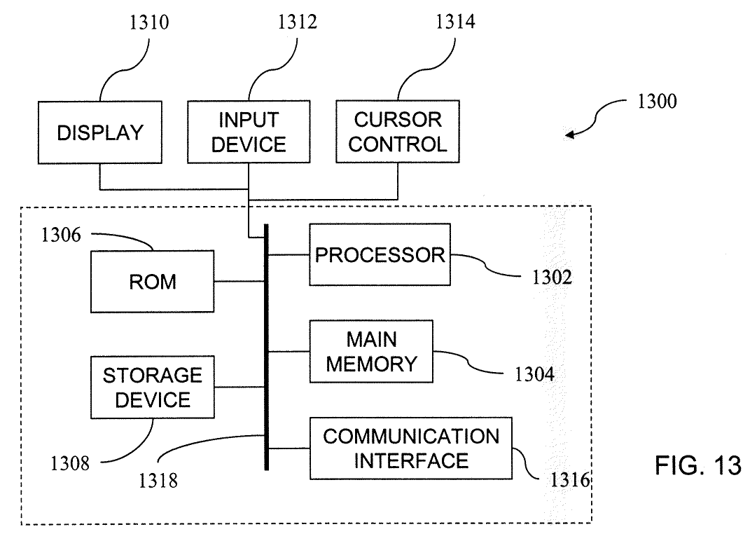

FIG. 13 illustrates an embodiment of a computer on which various embodiments of the invention may be implemented. In the implementation, a computer 1300 may include a bus 1318 or other communication mechanism for communicating information and a processor 1302 coupled to the bus 1318 for processing information. The computer 1300 also includes a main memory 1304, such as random access memory (RAM) or other dynamic storage device, coupled to the bus 1318 for storing computer readable instructions by the processor 1302.

The main memory 1304 also may be used for storing temporary variables or other intermediate information during execution of the instructions to be executed by the processor 1302. The computer 1300 further includes a read only memory (ROM) 1306 or other static storage device coupled to the bus 1318 for storing static information and instructions for the processor 1302. A computer readable storage device 1308, such as a magnetic disk or optical disk, is coupled to the bus 1318 for storing information and instructions for the processor 1302. The computer 1300 may be coupled via the bus 1318 to a display 1310, such as a liquid crystal display (LCD) or a cathode ray tube (CRT), for displaying information to a user. An input device 1312, including, for example, alphanumeric and other keys, is coupled to the bus 1318 for communicating information and command selections to the processor 1302. Another type of user input device is a cursor control 1314, such as a mouse, a trackball, or cursor direction keys for communicating direct information and command selections to the processor 1302 and for controlling cursor movement on the display 1310. The cursor control 1314 typically has two degrees of freedom in two axes, a first axis (e.g., x) and a second axis (e.g., y), that allow the device to specify positions in a plane.

The term “computer readable instructions” as used above refers to any instructions that may be performed by the processor 1302 and/or other component of the computer 1300. Similarly, the term “computer readable medium” refers to any storage medium that may be used to store the computer readable instructions. Such a medium may take many forms, including, but not limited to, non volatile media, volatile media, and transmission media. Non-volatile media include, for example, optical or magnetic disks, such as the storage device 1308. Volatile media include dynamic memory, such as the main memory 1304. Transmission media include coaxial cables, copper wire and fiber optics, including wires of the bus 1318. Transmission media can also take the form of acoustic or light waves, such as those generated during radio frequency (RF) and infrared (IR) data communications. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

Various forms of the computer readable media may be involved in carrying one or more sequences of one or more instructions to the processor 1302 for execution. For example, the instructions may initially be borne on a magnetic disk of a remote computer. The remote computer can load the instructions into its dynamic memory and send the instructions over a telephone line using a modem. A modem local to the computer 1300 can receive the data on the telephone line and use an infrared transmitter to convert the data to an infrared signal. An infrared detector coupled to the bus 1318 can receive the data carried in the infrared signal and place the data on the bus 1318. The bus 1318 carries the data to the main memory 1304, from which the processor 1302 retrieves and executes the instructions. The instructions received by the main memory 1304 may optionally be stored on the storage device 1308 either before or after execution by the processor 1302.

The computer 1300 may also include a communication interface 1316 coupled to the bus 1318. The communication interface 1316 provides a two-way data communication coupling between the computer 1300 and a network. For example, the communication interface 1316 may be an integrated services digital network (ISDN) card or a modem used to provide a data communication connection to a corresponding type of telephone line. As another example, the communication interface 1316 may be a local area network (LAN) card used to provide a data communication connection to a compatible LAN. Wireless links may also be implemented. In any such implementation, the communication interface 1316 sends and receives electrical, electromagnetic, optical, or other signals that carry digital data streams representing various types of information. The storage device 1308 can further include instructions for carrying out various processes for image processing as described herein when executed by the processor 1302. The storage device 1308 can further include a database for storing data relative to same.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit of the invention as set forth herein.

What is claimed is:

1. A reading-assistance method comprising:
receiving a string of text, the string of text comprising a plurality of words arranged in a predetermined order having at least a first word;
receiving a list of words of interest;
wherein the words of interest are a subset of the plurality of words;
tagging each of the plurality of words that corresponds to a word of interest of the words of interest;
displaying at least a portion of the plurality of words;
highlighting each of a plurality of subsets of the plurality of words for a predetermined amount of time and in a predetermined order;
wherein only one subset of the plurality of subsets is highlighted at a time;
wherein an order in which the plurality of subsets is highlighted corresponds to the predetermined order of the plurality of words; and
wherein a predetermined amount of time for highlighting a subset of the plurality of subsets that comprises a tagged word is greater than a predetermined amount of time for highlighting a subset of the plurality of subsets that comprises only non-tagged words.

2. The method of claim 1, wherein the list of words of interest comprises at least one word selected from the group consisting of:
user-defined keywords;
search keywords used in a search to generate a document set;
concept keywords relating to a subset of a plurality of documents; and
linguistic keywords automatically generated based on linguistic processing.

3. The method of claim 1, wherein the highlighting step comprises increasing a font size.

4. The method of claim 1, comprising highlighting a previously highlighted subset in response to user input.

5. The method of claim 1, comprising displaying a word of a highlighted subset in an increased font and in a position above the displayed at least a portion of the plurality of words.

6. The method of claim 1, wherein
the at least a portion of the plurality of words is displayed in a columnate format having columns of a predetermined width; and
the width of the columns is related to a document type.

7. The method of claim 1, wherein tagged words are displayed in a bold font.

8. A reading-assistance method comprising:
storing user-reading statistics;
wherein the user-reading statistics comprise correlation data between a plurality of document types and a set of display settings used by a user to display each of the plurality of document types;
storing user-specified preferences;
wherein the user-specified preferences comprise settings for displaying at least one of the plurality of document types;
receiving a document to be displayed, the document comprising a plurality of words arranged in a predetermined order;
analyzing the document to determine a document type of the analyzed document;
selecting a manner for displaying the document based in at least partial dependence on the user-reading statistics for the document type and the user-specified preferences for the document type of the analyzed document; and
displaying the document in the manner.

9. The method of claim 8, wherein the steps are performed in the order listed.

10. The method of claim 8, comprising updating the user-reading statistics after the manner for displaying has been selected.

11. The method of claim 8, wherein the manner for displaying is chosen from the group comprising:
a speed-reading manner;
a utility-reading manner;
a pleasure-reading manner; and
a learning-reading manner.

12. The method of claim 8, wherein the document to be displayed is received from at least one of the group comprising:
a document search conducted using a web-searching algorithm;
a file search conducted on an electronic storage device; and
an email search conducted on an email viewing program.

13. The method of claim 8 wherein the set of display settings comprise one or more of:
a scrolling speed;
a highlight speed;
a highlight size;
an RSVP speed;
a font size and a font color;
a background color; and
a column width.

14. The method of claim 8, wherein the user-reading statistics comprise correlation data between a document and a set of display settings used by a plurality of users to display the document.

15. A reading-assistance method comprising:
receiving a string of text, the string of text and comprising a plurality of words arranged in a predetermined order;
storing a list of words of interest;
wherein the words of interest are a subset of the plurality of words;
analyzing the string of text for the words of interest;
wherein at least one area of the string of text comprising a relatively high concentration of words of interest is identified as important;
wherein at least one area of the string of text comprising a relatively low concentration of words of interest is identified as non-important;
displaying the string of text;
wherein each of a plurality of subsets of the string of text are displayed for a predetermined amount of time and in a predetermined order; and
wherein a predetermined amount of time for displaying a subset of the string of text corresponding to the at least one area identified as important is greater than a predetermined amount of time for displaying a subset of the string of text corresponding to the at least one area identified as non-important.

16. The method of claim 15 wherein the list of words of interest comprises keywords used in a database search.

17. The method of claim 15, wherein the list of words of interest comprises words from at least one area a user has tagged as important.

18. The method of claim 15, wherein the string of text is an email.

19. The method of claim 15, comprising using the list of words of interest to locate areas of importance in a plurality of documents.
